(19) United States
(12) Patent Application Publication
(10) Pub. No.: US 2025/0187054 A1
(43) Pub. Date: Jun. 12, 2025

(54) SYSTEM FOR RECYCLING WASTE PLASTER ORIGINATING FROM THE GENERAL PUBLIC AND RECYCLING METHOD IMPLEMENTING SUCH A SYSTEM

(71) Applicant: HOLDING RITLENG, Rohr (FR)

(72) Inventors: Jean-Luc RITLENG, Rohr (FR); Geoffrey RITLENG, Rohr (FR); Arnaud RITLENG, Rohr (FR)

(21) Appl. No.: 18/845,395

(22) PCT Filed: May 25, 2022
(86) PCT No.: PCT/EP2022/064252

§ 371 Date: Sep. 9, 2024

(30) Foreign Application Priority Data
Mar. 9, 2022 (FR) FR2202042

(51) Int. Cl. B09B 3/35; B03B 9/06; B03C 1/30

(52) U.S. Cl. CPC B09B 3/35; B03B 9/065; B03C 1/30; B03C 2201/20

(57) ABSTRACT

The invention relates to a system (1) for recycling waste plaster originating from the general public and intended to recover a fraction, referred to as final fraction, comprising elements of particle size smaller than or equal to a determined threshold size, the system (1) comprising: • at least one waste preparation unit (2); • at least one unit (3) for crushing and sorting the waste from the preparation unit (2); • at least one recovery unit (5) recovering at least part of the fine fraction from the crushing and sorting unit (3); the system (1) being characterized in that it further comprises at least one finalization unit (4) receiving at least part of the coarse fraction from the crushing and sorting unit (3), the finalization unit (4) comprising at least one rolling mill having a roll separation less than or equal to the threshold dimension.

### FIELD OF THE INVENTION

The present invention relates to the field of recycling plaster, and more specifically to the field of recovering gypsum from the waste plaster originating from the general public, in particular from the demolition and/or renovation of buildings.

More specifically, the invention relates to a system making it possible to recycle waste plaster for recovering the gypsum therefrom.

### TECHNICAL BACKGROUND

Plaster is a hydraulic binder typically obtained from gypsum, a material that is found in the natural state in nature, worked in quarries. However, the costs of exploitation, the environmental problems and the exhaustion of the natural resources lead to the development of a recycling solution for recovering the gypsum from waste plaster.

Waste plasters originating from the general public have varied origins, and are often closely mixed with other materials. For example, there may be mentioned:
plaster known as simple plaster, for example any board composed of gypsum covered with a paper facing,
plaster tiles,
plaster mouldings,
plaster originating from ceilings and mixed with linen, reed, wood lath, etc.,
plaster known as complex plaster, covered for example with glass wool, rockwool, polystyrene, etc.,
plaster covered with earthenware, metal, plastic from electrical trunking, etc.

Two categories of plaster recycling methods can be distinguished: those known as chemical methods, generally involving a thermal treatment and the use of water, and those known as mechanical, essentially based on grinding and sorting. The invention relates to a type of method known as mechanical, which is easier to implement and less costly than chemical methods.

Mechanical methods encounter several difficulties. In fact, the adherent nature of plaster makes it difficult to detach from the other materials, more particularly from papers and cardboards. Thus, during grinding, the papers and cardboards are also ground, making it difficult to separate them from the gypsum. Furthermore, ambient moisture can increase adhesion between the plaster and the paper and cardboards, as well as clogging the equipment.

The document US2016/0214895 describes an example of a method for mechanical recycling of gypsum from construction materials, which comprises successive steps of sorting, grinding and screening, in order to separate the particles of gypsum from the paper and from the cardboard.

In the document EP1421995, it is proposed to introduce a crushing step into a plaster recycling method of the mechanical type, in order to make the materials more brittle and to promote their dislocation in a drum.

The document US2017/341084 also describes an example of a recycling line with successive grinding and screening.

However, these methods do not make it possible to reach sufficient levels of productivity and purity of the recovered gypsum, such that the rejects from these methods constitute significant waste that must be treated, increasing the costs of recycling plaster and reducing its ecological benefit.

In fact, in order to reach a high gypsum purity rate at the end of the recycling, the materials must be sorted to the smallest possible dimensions. However, the smaller the sorting dimensions, the trickier it is to extract the gypsum with good productivity, as the rejects contain a non-negligible proportion of gypsum. Thus the result thereof is that either the productivity level is low, such that the rejects, still comprising plaster, are significant, are difficult to upcycle and must be treated, or the purity of the gypsum recovered is low, limiting its use as a replacement for the natural gypsum extracted directly from the quarries.

Thus the invention aims to overcome in particular the aforementioned drawbacks by proposing a new solution for recycling plaster originating from the general public, by a method improving the recycling productivity in particular, by improving the productivity level as well as the purity rate of the gypsum recovered.

Thus, a first subject of the invention is to propose a solution making it possible to recover the gypsum from waste plaster originating from the general public with increased cost-effectiveness.

A second subject of the invention is to propose a solution making it possible to recover the gypsum from waste plaster originating from the general public that is fully mechanical.

A third subject of the invention is to propose a solution making it possible to recover the gypsum from waste plaster originating from the general public making it possible to obtain a purity rate of the gypsum recovered that is higher than in the prior art.

A fourth subject of the invention is to propose a solution making it possible to recover the gypsum from waste plaster originating from the general public making it possible to efficiently separate the gypsum from the other materials in order to upcycle these other materials.

A fifth subject of the invention is to propose a solution making it possible to recover the gypsum from waste plaster originating from the general public and to reduce the recycling costs.

A sixth subject of the invention is to propose a solution making it possible to recover the gypsum from waste plaster originating from the general public while being able to use equipment that is already available on the market.

### SUMMARY OF THE INVENTION

Thus, according to a first aspect, the invention relates to a system for recycling waste plaster originating from the general public intended to recover a fraction called final fraction comprising elements having a particle size less than or equal to a determined threshold dimension. The system comprises in particular:
at least one waste preparation unit, which comprises at least one magnetic sorting device making it possible to at least partially separate metal elements from the rest of the waste;
at least one unit for grinding and sorting the waste originating from the preparation unit, which comprises at least one grinding unit and at least one sorting unit having a mesh less than or equal to the threshold dimension, making it possible to separate the waste into a fine fraction and a coarse fraction;
at least one recovery unit recovering at least a part of the fine fraction from the grinding and sorting unit.

The system also comprises at least one finalization unit receiving at least a part of the coarse fraction originating from the grinding and sorting unit. The finalization unit comprises at least one rolling mill having a roll gap less than or equal to the threshold dimension followed by at least one finalization sorting device having a mesh less than or equal to the threshold dimension and feeding the recovery unit.

The entirety of the fine fractions recovered by the recovery unit thus correspond to the final fraction having a particle size less than or equal to the threshold dimension.

The system thus makes it possible to recover a fine fraction the particle size of which can be very small, so as to obtain a high purity rate, as well as extracting the gypsum with high productivity. In particular, implementation of a rolling mill after the grinding device makes it possible to perform more efficient sorting.

According to different aspects, it is possible to provide one and/or the other of the characteristics hereinafter taken alone or in combination.

Thus, the grinding-sorting device and the finalization sorting device can each comprise at least one screen of the flip-flop type. The flip-flop type screen makes it possible in particular to limit the risks of clogging the screen, while providing an adequate sorting quality.

According to an embodiment, the at least one rolling mill of the finalization unit comprises smooth rollers, i.e. having no asperities on the scale of the threshold dimension.

For example, the threshold dimension is less than or equal to 1.2 mm or less than or equal to 1 mm, which makes it possible to reach a recycling rate up to 99%, as well as a rate of replacement of natural gypsum of the order of 60%.

According to an embodiment, the grinding device comprises for example at least one rejects outlet connected to the finalization unit, such that the finalization unit receives at the same time a coarse fraction from the sorting and grinding unit and the rejects from the grinding device. Thus, the recycling rate is further improved by treating the rejects from the grinding device.

More particularly, the finalization unit can comprise at least two successive rolling mills. The rejects outlet of the grinding device can then be connected to the finalization unit between the two rolling mills, such that a first rolling mill receives exclusively the coarse part from the sorting and grinding unit and the second rolling mill receives a mixture comprising the waste passed by the first rolling mill and the rejects part from the grinding device. The crushing effect on the waste in the second rolling mill is thereby improved, making it possible to increase the rate of extraction of the gypsum from the waste, and therefore the recycling rate.

According to an embodiment, the grinding device comprises at least one bladed grinder, which makes it possible to grind the waste efficiently.

According to an embodiment, the waste preparation unit comprises a table for visual sorting of the waste. The waste that is easily recognized as non-compliant for treatment in the rest of the system is thus removed from the start, avoiding their obstructing the downstream items of equipment.

According to a second aspect, the invention relates to a method for recycling waste plaster originating from the general public intended to recover a fraction called final fraction comprising elements having a particle size less than or equal to a determined threshold dimension, by implementation of the system as set out above. The method comprises in particular:
determining the threshold dimension,
adjusting the grinding and sorting unit as well as the finalization unit to the determined threshold dimension;
Passing the waste into the recycling system.

It is thus possible to select a threshold dimension as a function of the desired results, in particular in terms of recycling rate and purity of the recycled gypsum.

### BRIEF DESCRIPTION OF THE DRAWINGS

Embodiments of the invention will be described hereinafter with reference to the drawings, briefly described below:

FIG. 1 represents a diagram of a recycling system according to an embodiment of the invention;

FIG. 2 represents diagrammatically a waste preparation unit of the system in [FIG. 1];

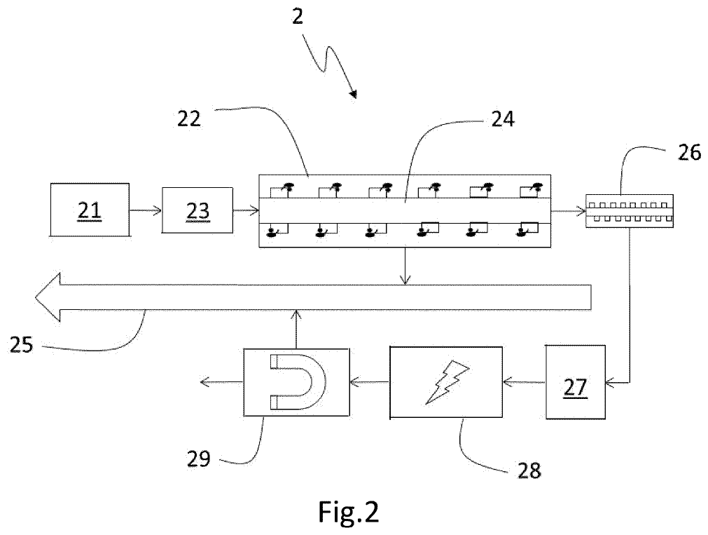

FIG. 3 represents diagrammatically a sorting and grinding unit and a finalization unit of the system in [FIG. 1].

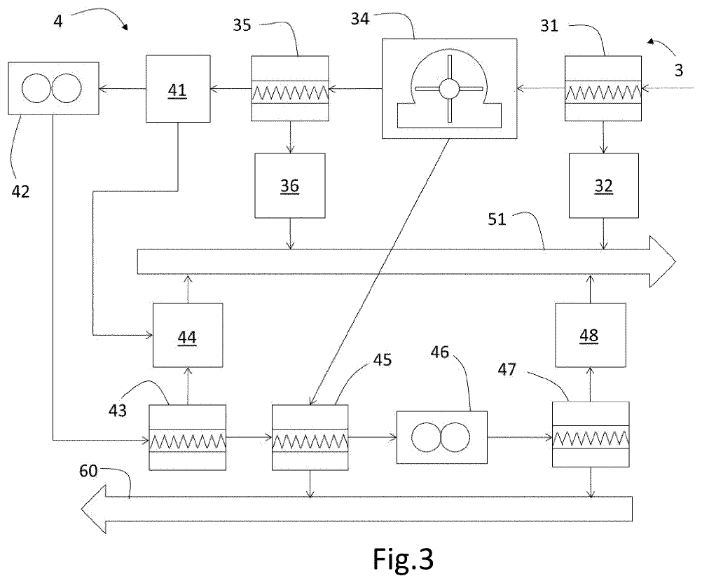

In the figures, identical reference signs denote identical or similar objects.

### DETAILED DESCRIPTION

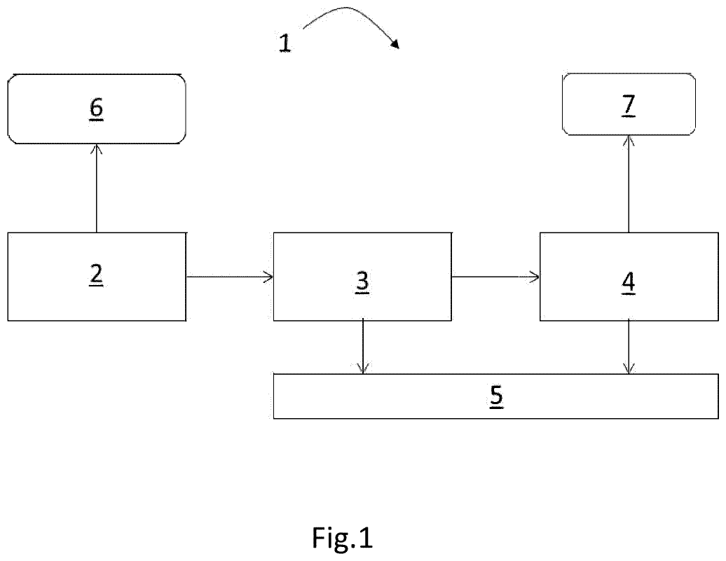

FIG. 1 represents diagrammatically a waste plaster recycling system 1 according to an embodiment according to the invention. The wastes are referred to as originating from the general public, i.e. they come from diverse origins, without distinction. They comprise in particular waste plaster used in the field of construction, demolition, industrial applications and/or from private homes.

The system 1 is for example installed on a site close to the storage area of the untreated waste.

The recycling system 1 makes it possible to recover, from the waste, a fraction called final fraction, comprising elements having a particle size less than or equal to a threshold dimension. By “particle size” is meant here the dimension of the elements determined by any particle size analysis method. Hereinafter, the dimension of the elements therefore makes reference to a dimension determined by any particle size analysis method.

The threshold dimension is selected, predetermined, as a function in particular of the targeted result, as characterizing the particle size of the final fraction.

The system 1 comprises a succession of three units, namely a unit 2 for preparation of the waste, a unit 3 for grinding and sorting, and a unit 4 for finalization. Each unit 2, 3, 4 comprises a succession of stations, an embodiment of which is detailed hereinafter. The system also comprises a recovery unit 5, which collects fractions generated throughout the system 1 corresponding to the final fraction. Although this is not mentioned each time, between each station and each unit, a waste convoy system can be provided, for example of the conveyor belt type.

The unit 2 for preparation of the waste has the function of preparing the waste for the grinding and sorting step which takes place in the unit 3 for grinding and sorting, in particular by removing untreated waste materials that can be immediately recognized.

More specifically, the preparation unit 2 comprises a feed bunker 21, into which the untreated waste is tipped. The untreated waste comprises various materials, in the form of elements of varied dimensions, capable of reaching up to 300 mm (millimetres) or even larger. The bunker 21 makes it possible in particular to control and maintain a determined waste flow. It then feeds a first screen 23, for example of the star type, making it possible to carry out a first particle size separation on the dimension of the elements around a given value, so as to obtain a fraction called fine fraction, having a smaller dimension than the given value, for which a visual sorting is difficult if not impossible, and a fraction called coarse having a greater dimension than the given value, which can be sent to a sorting table 24. The given value for the sorting in the first screen 23 is for example less than 100 mm (millimetres), and for example equal to 50 mm. A grinder can be provided upstream of the first screen 23, for example in the case where the waste has dimensions incompatible with the first screen 23. In addition a metal sorting device, for example of the overband magnet type, can also be provided upstream of the first screen 23 in order to remove the metal elements that are already accessible.

Hereinafter, for each device making it possible to carry out a particle size separation around a given adjustment value, a fine fraction is defined corresponding to the particle size elements smaller than, or equal to, the adjustment value of the device in question and a coarse fraction corresponding to the elements having dimensions greater than the adjustment value of the device in question.

The sorting table 24 makes it possible for example for operators to perform visual sorting, and to remove elements from the waste that are immediately recognized as non-compliant, such as elements of wood, plastic, bricks, metal parts or pieces of polystyrene. The sorting table 24 is for example placed in a closed, air-conditioned cabin 22, providing human operators with good working conditions. The non-compliant elements are then visually recognized, removed manually or using items of equipment, and discharged onto an output belt 25, optionally in order to upcycle them in a dedicated circuit 6. The cabin 22 is for example formed from a self-supporting structure, at height with respect to the feed bunker 21.

The compliant waste elements output from the sorting table 24 can then be sent to a screw grinder 26, in which the waste is ground by slow mechanical pressure in order to reduce the dimension thereof to a maximum dimension for example of 200 mm. The screw grinder 26 can comprise a system with one or more screw rollers, for example three, and makes it possible to obtain efficient grinding of the waste.

The waste output from the screw grinder 26 can then be mixed with the fine fraction output from the first star screen 23 before entering a sorting device to remove the metal objects. In fact, the metal objects missed by the operators on the sorting table 24 are preferably removed before the grinding and sorting unit, in order to ensure that they do not cause damage and/or premature wear in particular to the following devices, in particular the grinding device.

The sorting device comprises for example a device 27 of the overband magnet type, making it possible to recover metal objects. The overband can be followed by a sorting device 28 comprising a magnetization device, for example by generating a magnetic field through which the waste items pass and are electrically charged by Foucault currents. Then by using a magnetic head 29 over the waste, the elements thus magnetized are extracted.

The non-compliant elements thus extracted from the waste in the preparation unit 2, and essentially the metal elements, are discharged for example using the output belt 25, and can optionally be upcycled in a separate circuit, such as the dedicated circuit 6.

The waste with the majority of the non-compliant elements thus removed is then treated in the grinding and sorting unit 3. Their maximum dimension is 200 mm, according to the example detailed here.

The grinding and sorting unit 3 comprises in particular at least one grinding device and at least one sorting device called grinding-sorting device, adjusted to the threshold dimension for recovering elements of dimensions corresponding to the final fraction. According to an example, the threshold dimension is less than 1.5 mm, preferably less than 1.2 mm, and more preferably less than or equal to 1 mm.

For this purpose, the grinding and sorting unit 3 can comprise a first grinding-sorting device comprising for example a second screen 31, for example of the trampoline type, also called flip-flop screen, having a mesh adjusted to the threshold dimension, i.e. the output mesh of which is smaller than or equal to the threshold dimension, and which carries out a first separation between a fine fraction, forming part of the final fraction which is sent to the recovery unit 5, for example on an output belt 51 of the recovery unit 5, and a coarse fraction. Use of a screen of the flip-flop type makes it possible in particular to limit the risk of clogging the apertures of the screen. The shaking of the flip-flop screen also contributes to separating the plaster from the other materials. Optionally, the first grinding-sorting device can comprise a sieve 32, for example of the oscillating type, having a mesh adjusted to the threshold dimension, and which is interposed between the second screen 31 and the output belt 51, in order to prevent elements with dimensions greater than that of the threshold dimension and which have managed to pass through the second screen 31 ending up on the output belt 51 and in the final fraction.

The coarse fraction output from the second screen 31 is sent to a grinding device 34. The grinding device 34 preferably comprises a percussion mill, and more preferably a bladed grinder, in which the coarse fraction from the second grinder 31 is beaten against a grid in particular in order to detach the gypsum adhering to the facings of paper and/or cardboard. According to an example embodiment, the grid of the grinder 34 has a mesh with aperture dimension less than 200 mm, and for example of 40 mm. Thus, the grinder 34 generates a coarse fraction having a dimension greater than or equal to 40 mm, called grinder oversize, and a fine fraction of dimension less than 40 mm which is sent to a second grinding-sorting device, which comprises for example third screen 35, which can be of the same type as the first screen 31, and has a mesh adjusted to the threshold dimension. The third grinder 35 also has a mesh adjusted to the threshold dimension, such that it carries out a separation between a fine fraction and a coarse fraction, as for the second grinder 31. The second sorting device can also comprise a second oscillating sieve 36, similar to the first oscillating sieve 33, through which passes the fine part output from the third grinder 35, in order to be discharged, for example onto the same output belt 32, and to join the fine fraction originating from the first oscillating sieve 31.

The grinding and sorting unit 3 can comprise other successive grinding and sorting devices.

According to the invention, the grinding and sorting unit 3 is followed by the finalization unit 4 that receives the coarse fraction output from the third screen 35, i.e. the dimension of the elements of which is greater than the threshold dimension.

The finalization unit 4 comprises at least one rolling mill followed by at least one sorting device called finalization sorting device.

More specifically, according to the embodiment shown in the figures, the finalization unit 4 can comprise a fourth screen 41, for example of the star type, which receives the coarse fraction from the third screen 35 of the grinding and sorting unit 3. The fourth star screen 41 makes it possible to further separate and break up the materials, in particular the gypsum from the paper and/or from the cardboard, on elements having reduced dimensions, after passing through the grinding and sorting unit 3. The fourth screen 41 is adjusted for example to a dimension greater than the threshold dimension, for example to a dimension greater than the threshold dimension by a factor greater than 1, which can be comprised between 1.2 and 2. For example, when the threshold dimension is 1 or 1.2 mm, the second, star screen 41 can be adjusted to the dimension 1.5 or 2 mm. The fourth screen 41 thus generates a fine fraction, but which does not correspond to the final fraction, and a coarse fraction.

The finalization unit 4 then comprises at least one first rolling mill 42 that follows the fourth screen 41, and which receives the coarse part from the fourth screen 41. This coarse part can comprise, according to the example presented here, elements having dimensions up to 30 mm, or even 40 mm. The first rolling mill 42 comprises at least two rollers the surface of which is smooth, so as to crush the elements without shredding or grinding them, promoting the separation of the gypsum from the other materials.

By “smooth” is meant here the absence of patterns and/or asperities on the surface of the rollers that enter into contact with the waste, at the scale of the threshold dimension.

The other materials are mainly paper and/or cardboard, which return to their initial shape and dimension on output from the first rolling mill 42. The roll gap, or gap width, between the rollers of the first rolling mill 42 is adjusted to a determined minimum value, for example corresponding to the threshold dimension.

The output from the first rolling mill 42 is then transported to a first finalization sorting device, which comprises for example a fifth screen 43 and a third sieve 44. The fifth screen 43 is for example of the flip-flop type, having a mesh adjusted to the threshold dimension. The fine fraction of the fifth screen 43 is sent to the third sieve 44 for example of the oscillating type, in order to feed the output belt 51 with a fine fraction corresponding to the final fraction. The fine fraction from the fifth screen 41 is also sent to the third sieve 44, so as to recover therefrom the elements having a particle size corresponding to the final fraction.

The coarse fraction from the fifth screen 43 is transported to a sixth screen 45, for example of the flip-flop type, which also receives the rejects from the grinder 34 of the grinding and sorting unit. These rejects are mixed with the coarse fraction from the fifth screen 43 in the sixth screen 45, which has mesh adjusted to a dimension greater than the threshold dimension. For example, its mesh is adjusted to 8 mm. This makes it possible to allow the elements having large dimensions to pass, such as papers and cardboards, to which the gypsum still adheres. The coarse fraction from the sixth screen 45 can be recovered for example on a dedicated belt 60 for paper. At this stage the coarse fraction from the sixth screen 45 is deemed to comprise almost exclusively paper and/or cardboard.

The fine portion from the sixth screen 45 then passes through a second rolling mill 46, also having smooth rollers, in order to crush and not to grind or shred the elements. The mixture of the fine portion from the sixth screen 45 and the rejects from the grinder 34, which comprise elements having dimensions greater than that of the fine portion, increases the rolling efficiency in the second rolling mill 46. The roll gap of the second rolling mill 46 is adjusted to a value less than or equal to the threshold dimension, such that the last elements of gypsum still adhering to paper and/or cardboard and which are found in the fine fraction from the sixth screen 45 are detached, without degrading the papers and/or cardboards.

The output from the second rolling mill 46 is then sent to the fourth sorting device, comprising for example a seventh screen 47 and a fourth sieve 48. The seventh screen 47 is for example of the flip-flop type, having a mesh adjusted to the threshold dimension. The coarse fraction from the seventh screen 47 is sent to the belt 60 for paper, and the fine fraction is sent to the fourth sieve 48 having a mesh adjusted to the threshold dimension before joining the output belt 51.

The entirety of the fine fractions recovered in the recovery unit 5, on the output belt 51, then form the final fraction, comprising elements having a particle size less than or equal to the threshold dimension, and containing almost exclusively gypsum.

Implementation of one or more rolling mills after grinding makes it possible to extract with greater efficiency the gypsum adhering to other materials, and in particular paper and/or cardboard.

In fact, when passing through a rolling mill, an element for example formed of paper or cardboard, with plaster adhering thereto, is then deformed, crushed between the rollers, such that the plaster, more brittle than the paper or the cardboard, is detached and disintegrates into smaller elements, while the paper or the cardboard return to their initial shape after passing therethrough.

By performing the rolling after grinding, on elements having dimensions reduced by the grinding, the adjustment of the roll gap between the rollers of the rolling mill can be adapted to the targeted threshold dimension, allowing recovery of the gypsum in a more efficient manner.

Thus, the smaller the dimension, the greater the efficiency of recovery of the gypsum. In fact, by virtue of the system thus described, for a plaster sheet with a paper support, up to 99% of the gypsum can be recovered. Furthermore, the final fraction recovered in the recovery unit 5 has a higher gypsum purity rate than in the prior art, such that this final fraction can be used as a replacement for natural gypsum, originating directly from a quarry, with a replacement rate of the order of 60%.

As already indicated, the non-compliant elements output from the preparation unit 2 can be upcycled in a dedicated circuit 6. Similarly, the coarse fractions output from the finalization unit 4, and in particular from the screens 43, 45 and 47, can also be upcycled in a dedicated circuit 7.

The system 1 thus described makes it possible to implement a method for recycling waste plaster originating from the general public, in which the threshold dimension is determined beforehand as a function in particular of the desired result, then by passing the waste successively through the preparation unit 2, the grinding and sorting unit 3, and the finalization unit 4, so as to recover the final fraction in the recovery unit 5.

1. System (1) for recycling waste plaster originating from the general public intended to recover a fraction called final fraction comprising elements having a particle size less than or equal to a determined threshold dimension, the system (1) comprising:
at least one waste preparation unit (2), comprising at least one magnetic sorting device (27, 28, 29) making it possible to at least partially separate metal elements from the rest of the waste;
at least one unit (3) for grinding and sorting the waste originating from the preparation unit (2), comprising at least one grinding device (34) and at least one sorting device (31, 32, 35, 36) having a mesh less than or equal to the threshold dimension, making it possible to separate the waste into a fine fraction and a coarse fraction;
at least one recovery unit (5) recovering at least a part of the fine fraction from the grinding and sorting unit (3);
the system (1) being characterized in that it also comprises at least one finalization unit (4) receiving at least a part of the coarse fraction originating from the grinding and sorting unit (3), the finalization unit (4) comprising at least one rolling mill (42, 46) having a roll gap less than or equal to the threshold dimension followed by at least one finalization sorting device (43, 44, 47, 48) having a mesh less than or equal to the threshold dimension and feeding the recovery unit (5), the entirety of the fine fractions recovered by the recovery unit (5) corresponding to the final fraction.

2. Recycling system (1) according to claim 1, in which the grinding-sorting device (31, 32, 35, 36) and the finalization sorting device (43, 44, 47, 48) each comprise at least one screen (31, 35, 43, 47) of the flip-flop type.

3. Recycling system (1) according to claim 1, in which the at least one rolling mill (42, 46) of the finalization unit (4) comprises smooth rollers.

4. Recycling system according to claim 1, in which the threshold dimension is less than or equal to 1.2 mm.

5. Recycling system according to claim 4, in which the threshold dimension is less than or equal to 1 mm.

6. Recycling system (1) according to claim 1, in which the grinding device (34) comprises at least one rejects outlet connected to the finalization unit (4), such that the finalization unit (4) receives at the same time a coarse fraction from the sorting and grinding unit (3) and the rejects from the grinding device (34).

7. Recycling system (1) according to claim 6, in which the finalization unit (4) comprises at least two successive rolling mills (42, 45), the rejects output from the grinding device (34) being connected to the finalization unit (4) between the two rolling mills (42, 45), such that a first rolling mill (42) receives exclusively the coarse part from the sorting and grinding unit (3) and the second rolling mill (45) receives a mixture comprising the waste passed by the first rolling mill (45) and the rejects part from the grinding device (34).

8. Recycling system (1) according to claim 1, in which the grinding device (34) comprises at least one bladed grinder.

9. Recycling system (1) according to claim 1, in which the waste preparation unit (2) comprises a table for visually sorting waste (24).

10. Method for recycling waste plaster originating from the general public intended to recover a fraction called final fraction comprising elements having a particle size less than or equal to a determined threshold dimension, by implementation of the system (1) according to claim 1, the method comprising:
determining the threshold dimension;
adjusting the grinding and sorting unit (2) as well as the finalization unit (4) to the determined threshold dimension;
passing the waste into the recycling system (1).
